(19) United States
(12) Patent Application Publication
(10) Pub. No.: US 2026/0296396 A1
(43) Pub. Date: Oct. 1, 2026

(54) PROCESSOR DEVICE FOR A BRAKING SYSTEM, METHOD FOR OPERATING A PROCESSOR DEVICE, BRAKING SYSTEM AND VEHICLE

(71) Applicant: ZF Friedrichshafen AG, Friedrichshafen (DE)

(72) Inventors: Stefan Grieser-Schmitz, Koblenz (DE); Patrick Mueller, Mayen (DE); Florian Gerhartz, Büchel (DE)

(73) Assignee: ZF Friedrichshafen AG, Friedrichshafen (DE)

(21) Appl. No.: 19/630,314

(22) Filed: Mar. 26, 2026

(30) Foreign Application Priority Data
Mar. 27, 2025 (DE) 102025111847.7

(51) Int. Cl. B60W 10/18; G06F 11/20

(52) U.S. Cl. CPC B60W 10/18; G06F 11/2048

(57) ABSTRACT

A processor device for a braking system has a main processor for controlling at least one brake actuator during normal operation of the processor device, an auxiliary processor for controlling the at least one brake actuator in response to a detected malfunction of the main processor,, and a monitoring device for monitoring the main processor to detect the malfunction. The monitoring device is configured to control a switching unit when the malfunction has been detected. The switching unit is configured to switch a reading-in of sensor signals from the main processor to the auxiliary processor and/or an outputting of control signals to the at least one brake actuator from the main processor to the auxiliary processor in response to the detected malfunction. The auxiliary processor and the main processor are arranged in a common housing.

### CROSS-REFERENCE TO RELATED APPLICATIONS

This application claims priority to German Patent Application No. 102025111847.7, filed Mar. 27, 2025, the disclosure of which is incorporated herein by reference in its entirety.

### TECHNICAL FIELD

The present disclosure relates to a processor device for a braking system, to a method for operating a processor device, to a braking system and to a vehicle.

### BACKGROUND

Vehicles often have a plurality of processors, using which different vehicle functions are controlled. Such functions can also include safety-relevant functions, for example.

Against this background, the present disclosure provides an improved processor device for a braking system, an improved method for operating a processor device, an improved braking system and an improved vehicle as claimed in the main claims. Advantageous configurations emerge from the subclaims and the following description.

The presented approach can provide an opportunity to be able to make more efficient use of existing installation space in the vehicle and to reduce costs. Moreover, an opportunity can be provided to protect an occupant of the vehicle in emergency situations. Advantageously, an increase in availability can be achieved without the use of further external microprocessors and the corresponding control unit can be realized in a manner that is more compact and cheaper than comparable existing solutions.

### SUMMARY

A processor device for a braking system of a vehicle is presented herein. The processor device includes a main processor for controlling at least one brake actuator of the braking system during normal operation of the processor device, an auxiliary processor for controlling the at least one brake actuator in response to a detected malfunction of the main processor, a monitoring device for monitoring the main processor in order to detect the malfunction, and a switching unit which is designed to switch a reading-in of sensor signals from the main processor to the auxiliary processor. The auxiliary processor and the main processor are arranged in a common housing. The monitoring device is configured to control a switching unit when the malfunction has been detected. In addition, or alternatively, control signals may be output to the at least one brake actuator from the main processor to the auxiliary processor in response to the detected malfunction.

The processor device can advantageously do without an external separate microprocessor and at the same time an increase in availability can be achieved. The braking system can accordingly be designed as an electronic parking brake or carry out a function of the electronic parking brake. The vehicle can, for example, be realized as an electrified vehicle which can be designed to transport persons and, in addition or alternatively, objects. In this case, during normal operation, the main processor can control the operating functions of the processor device and at the same time monitor the auxiliary processor. The auxiliary processor can also be implemented as a replacement and thus as a backup for the main processor and take over its tasks in the event of an error so that an occupant of the vehicle can advantageously be protected. The malfunction, or the event of an error, can refer, for example, to a fault in the main processor. The processor device can thus be implemented cost-effectively and efficiently with regard to an existing installation space. The monitoring device can, for example, be designed as a control unit. The switching unit can, for example, be formed as a so-called switch which can be controlled by the monitoring device. The sensor signals that are read-in by the processor device can be read in via an interface to a plurality of vehicle sensors. Advantageously, the switching unit can activate emergency operation of the processor device by switching the reading-in and the outputting of the corresponding signals from the main processor to the auxiliary processor.

According to one exemplary arrangement, the main processor and the auxiliary processor can be arranged or formed on a common semiconductor chip. This can advantageously save installation space and costs.

The processor device can comprise a first energy supply unit for supplying electrical energy to the main processor and a second energy supply unit for supplying electrical energy to the auxiliary processor, the first energy supply unit and the second energy supply unit being able to be independent of each other. Advantageously, the energy supply units are able to ensure that both processors of the processor device are supplied with sufficient energy.

According to one exemplary arrangement, the at least one brake actuator of the braking system can be designed as an actuator of an electronic parking brake. This can advantageously generate an individual mechanical force which can be transmitted, for example, via mechanical cables to the rear brake installation.

Furthermore, the auxiliary processor can be formed to be able to additionally control an anti-lock braking functionality and/or anti-lock braking unit during emergency operation. Advantageously, safety for an occupant of the vehicle can be increased.

The main processor can be designed to be able to monitor functionality of the auxiliary processor and in addition or alternatively of the monitoring device and in addition or alternatively of the switching unit during normal operation. Advantageously, the main processor can additionally monitor and in addition or alternatively carry out a functionality of further components of the processor device during normal operation.

A method for operating a processor device in an above-mentioned arrangement for a braking system is additionally presented, the method comprising a reading-in step, a switching step and a control step. In the reading-in step, an error signal representing a malfunction of the main processor is read in. In the switching step, a reading-in of sensor signals is switched from the main processor to the auxiliary processor and in addition or alternatively an outputting of control signals to the at least one brake actuator is switched from the main processor to the auxiliary processor using the switching unit in response to the error signal. In the control step, the at least one brake actuator of the braking system is controlled using the auxiliary processor in response to the switching step.

The method can increase safety for a vehicle occupant, for example, during the journey, since the functionality of the braking system can be maintained by the processor device even if a malfunction has been detected internally.

According to one exemplary arrangement, the at least one brake actuator can be controlled in the control step in such a way as to be able to switch off non-safety-relevant system functions of the braking system. Non-safety-relevant system functions can include, for example, vehicle functions which, for example, reduce the likelihood of an accident occurring during a journey of the vehicle.

The approach presented here further provides a monitoring device which is designed to carry out, control or implement the steps of a variant of a method presented here, in corresponding devices. This exemplary arrangement of the disclosure in the form of a monitoring device can also be used to quickly and efficiently solve the problem on which the disclosure is based.

A monitoring device can be an electrical device which processes electrical signals, for example sensor signals, and outputs control signals on the basis thereof. The device can have one or more suitable interfaces which can be in the form of hardware and/or software. In hardware form, the interfaces can, for example, be part of an integrated circuit in which functions of the monitoring device are implemented. The interfaces can also be dedicated integrated circuits or at least partially consist of discrete components. In software form, the interfaces can be software modules which are present, for example, on a microcontroller alongside other software modules.

Also advantageous is a computer program product having program code which can be stored on a machine-readable carrier such as a semiconductor memory, a hard-disk memory or an optical memory and is used for carrying out the method according to one of the above-described exemplary arrangements when the program is executed on a computer or a device.

Furthermore, a braking system for a vehicle is presented, the braking system having a processor device in an above-mentioned exemplary arrangement and at least one brake actuator which is coupled to the processor device.

The braking system can advantageously be used for single-track and also for multi-track vehicles.

In addition, the disclosure relates to a vehicle, such as, for example, an at least partially electrified vehicle (which can also synonymously be understood as an electric vehicle or as an electrically driven vehicle), having a braking system in an above-mentioned arrangement and in addition or alternatively a processor device in an above-mentioned arrangement.

Advantageously, the vehicle can be designed as a passenger car but also as a truck.

### BRIEF DESCRIPTION OF THE DRAWINGS

The disclosure is explained in more detail by way of example with reference to the accompanying drawings. In the drawings:

FIG. 1 shows a schematic illustration of an exemplary arrangement of a vehicle;

FIG. 2 shows a block diagram of an exemplary arrangement of a braking system;

FIG. 3 shows a flowchart of an exemplary arrangement of a method for operating a processor device; and

FIG. 4 shows a block diagram of an exemplary arrangement of a monitoring device.

### DETAILED DESCRIPTION

In the following description of exemplary arrangements of the present disclosure, identical or similar reference signs are used for the elements with a similar effect illustrated in the various figures, a repeated description of these elements being omitted.

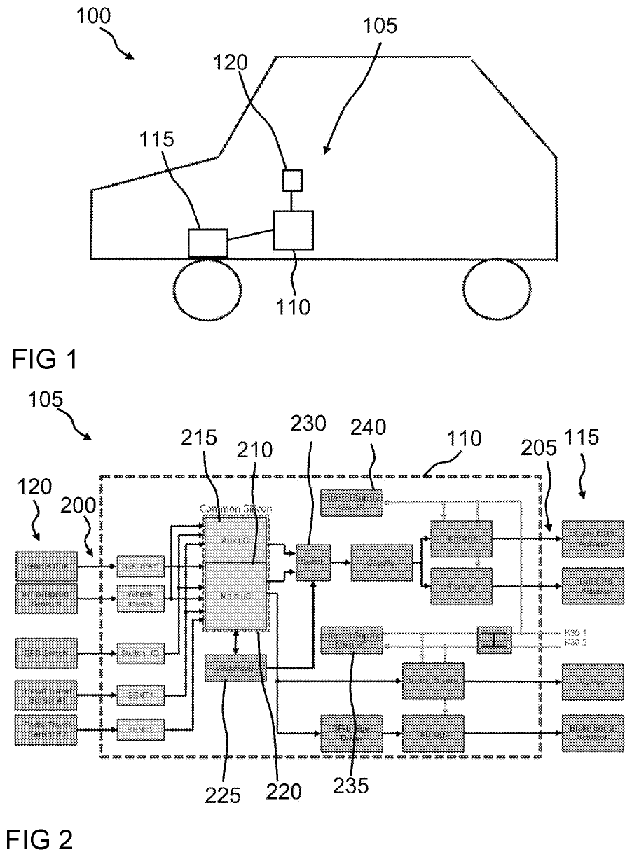

FIG. 1 is a schematic illustration of an exemplary arrangement of a vehicle 100. In this case, the vehicle 100 is designed, for example, as an electrified vehicle and has a braking system 105 and/or a processor device 110. In this case, the braking system 105 comprises the processor device 110 and at least one brake actuator 115 which is coupled to the processor device 110. According to this exemplary arrangement, the braking system 105 additionally has a sensor device 120 which in turn has, for example, a plurality of sensors. The braking system 105 and thus also the processor device 110 are described in more detail in at least one of the following figures. The braking system enables, for example, the function of an electronic parking brake and/or further vehicle functions related to the vehicle brake.

In other words, enhanced parking brake control is enabled by the processor device 110. For this purpose, use is made of an already existing auxiliary processor which is located with a main processor in a common housing and/or on a common semiconductor chip in order to achieve an increase in the reliability of the parking brake control. Moreover, the processor device 110 comprises a mechanism which detects a faulty main processor and automatically switches to the auxiliary processor, as described in more detail in at least one of the figures described below.

FIG. 2 shows a block diagram of an exemplary arrangement of a braking system 105 which corresponds, for example, to the braking system described in FIG. 1. In this case, the braking system 105 has the processor device 110 and at least one brake actuator 115 which is coupled to the processor device 110. According to this exemplary arrangement, the at least one brake actuator 115 and the processor device are electrically connected to each other. According to this exemplary arrangement, the sensor device 120 is also designed as part of the braking system 105 and is, for example, electrically coupled to the processor device 110. This means that the processor device 110 is designed to read in sensor signals 200 and to initiate, for example, a braking operation by using the sensor signals 200 which can be processed, for example, to output control signals 205 to the at least one brake actuator 115. In this case, the at least one brake actuator 115 is designed, for example, as an actuator of an electronic parking brake.

For this purpose, the processor device 110 has a main processor 210 for controlling the at least one brake actuator 115 of the braking system 105 during normal operation of the processor device 110. Moreover, the processor device 110 has an auxiliary processor 215 for controlling the at least one brake actuator 115 in response to a detected malfunction of the main processor 210, the auxiliary processor 215 and the main processor 210 being arranged in a common housing 220. The processor device 110 additionally has a monitoring device 225 for monitoring the main processor 210 in order to detect the malfunction. The monitoring device 225 is formed to control a switching unit 230 when the malfunction has been detected. The switching unit 230 is also formed as part of the processor device 110 and is also referred to, for example, as a switch. In this case, the switching unit 230 is designed to switch a read-in of the sensor signals 200 from the main processor 210 to the auxiliary processor 215 and/or an outputting of the control signals 205 to the at least one brake actuator 115 from the main processor 210 to the auxiliary processor 215 in response to the detected malfunction, for example to activate emergency operation of the processor device 110. The main processor 210 is designed to monitor functionality and/or operation of the auxiliary processor 215. The auxiliary processor 215 can, for example, act as a backup for the main processor 210 when the latter has an error or is not functioning correctly. For example, the auxiliary processor 215 is formed to additionally control an anti-lock braking functionality or an anti-lock braking unit during emergency operation.

According to this exemplary arrangement, the main processor 210 and the auxiliary processor 215 are arranged or formed on a common semiconductor chip. Furthermore, the main processor 210 is designed, for example, to monitor functionality of the auxiliary processor 215 of the monitoring device 225 and/or of the switching unit 230 during normal operation.

The processor device 110 additionally has a first energy supply unit 235 for supplying electrical energy to the main processor 210 and a second energy supply unit 240 for supplying electrical energy to the auxiliary processor 215. In this case, the first energy supply unit 235 and the second energy supply unit 240 are independent of each other, that is to say are able to be operated separately from each other.

In summary, the processor device 110 has the main processor 210, which is also referred to as “Main μC”, and takes over all control functions and monitoring of the auxiliary processor 215 (“Aux μC”) during normal operation. Moreover, the processor device 110 has the auxiliary processor 215 which reads in the driver's request in the event of an error and initiates corresponding control of the EPB. Optionally, this EPB control additionally includes a simple anti-lock braking function. According to this exemplary arrangement, the main processor 210 and auxiliary processor 215 are arranged in the common housing 220 or even on a common semiconductor chip. The switching unit 230 which is also referred to as a switch, is controlled by the monitoring device 225, which may also be referred to as a watchdog circuit, and thus determines whether the EPB control is carried out by the main processor 210 or the auxiliary processor 215, is also part of the processor device 110.

External sensors, which according to this exemplary arrangement have been described collectively as a sensor device 120, or other input signals which affect the EPB function, are part of the braking system 105 according to this exemplary arrangement. Normally, these are processed and/or evaluated by the main processor 210 and, in the event of an error, by the auxiliary processor 215. Two independent internal power supplies, which have been described as energy supply units 235, 240 and which supply power to the main processor 210 and the auxiliary processor 215 and optionally also a sensor evaluation and EPB control, are designed as part of the processor device 110.

In an error-free state (normal case), all system functions are carried out exclusively by the main processor 210. Correct control of the monitoring device 225 ensures that the EPB control is carried out by the main processor 210. Normally, the main processor 210 checks the function of the auxiliary processor 215, of the monitoring device 225 and of the switching unit 230 regularly. In the event of an error occurring in the main processor 210 or its peripherals (error event), the monitoring device 225 which detects the error event enables the EPB function to be switched to the auxiliary processor 215. In the event of an error, the auxiliary processor 215 possibly on the basis of the sensor signals 200-takes over the control of the EPB. The rest of the system functions are switched off, for example.

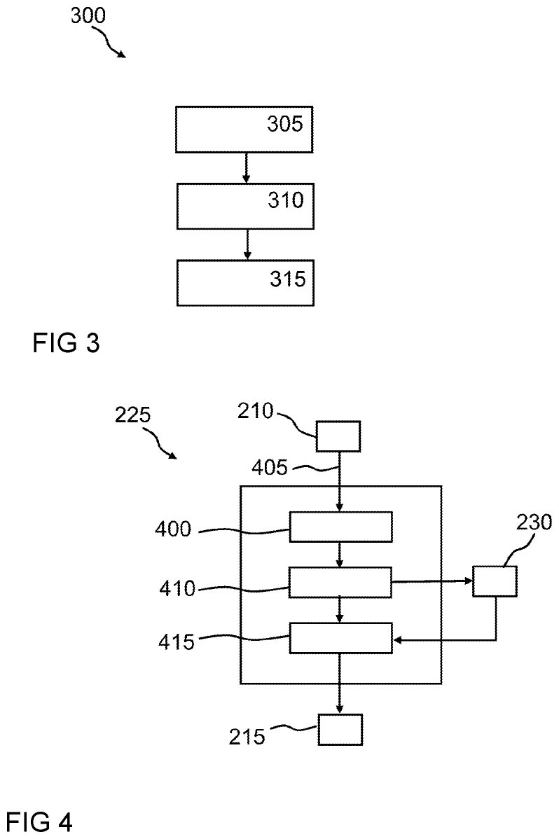

FIG. 3 shows a flowchart of an exemplary arrangement of a method 300 for operating a processor device, as described or at least mentioned, for example, in at least one of FIGS. 1 and 2. The method 300 comprises a step 305 of reading in an error signal representing a malfunction of the main processor, a switching step 310 and a control step 315. In the switching step 310, a reading-in of sensor signals is switched from the main processor to the auxiliary processor and/or an outputting of control signals to the at least one brake actuator is switched from the main processor to the auxiliary processor using the switching unit in response to the error signal. In the control step 315, the at least one brake actuator of the braking system is switched using the auxiliary processor in response to the switching step 310. Merely optionally, the at least one brake actuator is controlled in the control step 315 in such a way as to switch off non-safety-relevant system functions of the braking system. Non-safety-relevant system functions are, for example, those functions which, for example, reduce the likelihood of an accident occurring during a journey of the vehicle.

FIG. 4 shows a block diagram of an exemplary arrangement of a monitoring device 225 which corresponds, for example, to the monitoring device 225 described in FIG. 1. The monitoring device 225 comprises, for example, a control function and is thus set up to carry out and/or control the steps of the method, as described for example in FIG. 3, in corresponding units. The monitoring device 225 has a reading-in device 400 for reading in an error signal 405 representing a malfunction of the main processor 210, a switching device 410 which causes a reading-in of sensor signals to be switched from the main processor 210 to the auxiliary processor 215 and/or an outputting of control signals to the at least one brake actuator to be switched from the main processor 210 to the auxiliary processor 215 using the switching unit 230 in response to the error signal 405, and a control device 415 which causes the at least one brake actuator of the braking system to be controlled using the auxiliary processor 215 in response to the switching.

The exemplary arrangements described and shown in the figures are only chosen as examples. Different exemplary arrangements may be combined with each other in full or with respect to individual features. One exemplary arrangement can also be supplemented by features of another exemplary arrangement.

Furthermore, method steps according to the disclosure can be repeated as well as carried out in an order different than the one described.

If an exemplary arrangement comprises an “and/or” conjunction between a first feature and a second feature, this can be read in such a way that the exemplary arrangement, according to one configuration, has both the first feature and the second feature, and, according to another configuration, has either only the first feature or only the second feature.

1. A processor device for a braking system of a vehicle, the processor device comprising:
a main processor configured to control at least one brake actuator of the braking system during normal operation of the processor device;
an auxiliary processor configured to control the at least one brake actuator in response to a detected malfunction of the main processor, the auxiliary processor and the main processor being arranged in a common housing;
a monitoring device configured for monitoring the main processor to detect the malfunction, the monitoring device being configured to control a switching unit when the malfunction has been detected; and
the switching unit configured to switch a reading-in of sensor signals from the main processor to the auxiliary processor and/or an outputting of control signals to the at least one brake actuator from the main processor to the auxiliary processor in response to the detected malfunction.

2. The processor device as claimed in claim 1, the main processor and the auxiliary processor being arranged or formed on a common semiconductor chip.

3. The processor device as claimed in claim 1, having a first energy supply unit for supplying electrical energy to the main processor, and having a second energy supply unit for supplying electrical energy to the auxiliary processor, the first energy supply unit and the second energy supply unit being independent of each other.

4. The processor device (110) as claimed in claim 1, wherein the at least one brake actuator of the braking system is designed as an actuator of an electronic parking brake.

5. The processor device as claimed in claim 1, wherein the auxiliary processor is formed to additionally control an anti-lock braking functionality and/or anti-lock braking unit during emergency operation.

6. The processor device as claimed in claim 1, wherein the main processor is configured to monitor functionality of the auxiliary processor and/or of the monitoring device and/or of the switching unit during normal operation.

7. A method for operating a processor device as claimed in claim 1 for a braking system, the method comprising the following steps:
reading in an error signal representing a malfunction of the main processor;
switching a reading-in of sensor signals from the main processor to the auxiliary processor and/or an outputting of control signals to the at least one brake actuator from the main processor to the auxiliary processor using the switching unit in response to the error signal; and
controlling the at least one brake actuator of the braking system using the auxiliary processor in response to the switching step.

8. The method as claimed in claim 7, the at least one brake actuator being controlled in the control step so as to switch off non-safety-relevant system functions of the braking system.

9. A monitoring device which is set up to carry out and/or control the steps of the method as claimed in claim 7.

10. A computer program which is set up to carry out and/or control the steps of the method as claimed in claim 7.

11. A machine-readable storage medium on which the computer program as claimed in claim 10 is stored.

12. A braking system for a vehicle, the braking system comprising:
a processor device as claimed in claim 1; and
at least one brake actuator which is coupled to the processor device.

13. (canceled)
